(19) United States
(12) Patent Application Publication
(10) Pub. No.: US 2014/0116134 A1
(43) Pub. Date: May 1, 2014

(54) MICROMECHANICAL STRUCTURE

(71) Applicants: Johannes Classen, Reutlingen (DE); Rolf Scheben, Stuttgart (DE)

(72) Inventors: Johannes Classen, Reutlingen (DE); Rolf Scheben, Stuttgart (DE)

(73) Assignee: ROBERT BOSCH GMBH, Stuttgart (DE)

(21) Appl. No.: 14/061,970

(22) Filed: Oct. 24, 2013

(30) Foreign Application Priority Data
Oct. 25, 2012 (DE) 10 2012 219 511.4

(51) Int. Cl. G01C 19/5712

(52) U.S. Cl. CPC G01C 19/5712
USPC 73/504.12

(57) ABSTRACT

Micromechanical structure, in particular a yaw rate sensor having a substrate including a main plane of extent for detecting a first yaw rate about a first direction perpendicular to the main plane, a second yaw rate about a second direction parallel to the main plane, and a third yaw rate about a third direction parallel to the main plane and perpendicular to the second direction, includes a rotational oscillating element driven to rotational oscillation about a rotational axis parallel to the first direction. The micromechanical structure includes a yaw rate sensor configuration for detecting the first yaw rate that is completely surrounded by the rotational oscillating element in a plane parallel to the main plane. The micromechanical structure includes at least one first connection of the yaw rate sensor configuration on the rotational oscillating element, and at least one second connection of the yaw rate sensor configuration on the substrate.

### CROSS REFERENCE TO RELATED APPLICATION

The present application claims priority to Application No. DE 10 2012 219 511.4, filed in the Federal Republic of Germany on Oct. 25, 2012, which is expressly incorporated herein in its entirety by reference thereto.

### FIELD OF INVENTION

The present invention is directed to a micromechanical structure.

### BACKGROUND INFORMATION

Micromechanical structures and yaw rate sensors are known from the related art. For several years, such configurations have been manufactured in mass production for numerous applications in the automotive field and the consumer electronics field, among other things. The number of units of multiaxial yaw rate sensors manufactured has recently increased significantly. In the consumer electronics field, this relates in particular to triple-axle or triple-channel yaw rate sensors and micromechanical structures. In addition to aspects with regard to accuracy and the performance of the micromechanical structures otherwise, a small design size and thus also low costs of such micromechanical yaw rate sensors are important factors here. It is technically possible to situate a triple-channel yaw rate sensor (i.e., a yaw rate sensor having three sensitive axes or three sensitive directions, each typically being situated perpendicularly to one another) and three single-channel yaw rate sensors in one housing or in one configuration, for example, to place them on one chip. In addition, there are other known approaches in which the three-axle feature (or at least the yaw rate sensitivity with respect to two yaw rate axes, namely about an axis extending parallel to and an axis extending perpendicularly to the main plane of extent of the substrate) is represented via a complex coupled structure having a shared drive mode. These latter variants permit a reduced design size of the micromechanical structure or of the micromechanical or microelectromechanical component, so that the design size is reducible and a simpler evaluation circuit is implementable, which is an advantage for applications in consumer electronics in particular.

German Application No. DE 10 2008 042 369, for example, describes three sensor structures situated side by side, each sensor structure covering one measuring axis or one sensitive direction of the yaw rate sensor, the sensor structures situated side by side being interconnected by a shared drive bar. Due to this configuration, a relatively large amount of space is required for the micromechanical structure or the yaw rate sensor. With regard to a most extensive possible miniaturization, concepts in which a single mass may be used for detecting yaw rates about multiple axes appear much more promising. One example of this is a micromechanical structure having a rotating disk or a disk which executes rotational oscillations but whose function is limited initially to two sensitive axes of rotation parallel to the main plane of extent of the substrate, which is usually indicated by the fact that the sensitive axes of rotation or the axes of rotation are detectable by the yaw rates with which the x direction and the y direction are identified, where the x direction and the y direction correspond to the plane of the sensor substrate, and the corresponding yaw rates about these two axes perpendicular to one another are usually labeled as Ωₓ and Ω_{y}. The additional sensitivity of such a micromechanical structure about the third direction in space, usually labeled as Ω_{z} sensitivity and Ω_{z} functionality, i.e., the sensitivity during a rotation of the micromechanical structure about the z axis, which is perpendicular to the plane of the sensor substrate, must be ensured via additional structures.

For this purpose, European Application No. EP 183 2841 and U.S. Patent Application Publication No. 2010/0154541 propose linear oscillators, which are situated in recesses in the disk or the rotational oscillation configuration and are movably connected to the disk by springs. One major disadvantage of such structures is that not only the Coriolis force but also strong centrifugal forces act on the detection masses for Ω_{z} detection, and these forces are massively superimposed on the Coriolis signal, which is the useful signal. The amount of the Coriolis force is proportional to two times the product of the mass of the seismic mass, the velocity perpendicular to the axis of rotation and the yaw rate. The absolute value of the centrifugal force is proportional to the mass of the seismic mass, the square of the angular frequency and the radius about the axis of rotation. If the velocity (perpendicular to the axis of rotation) is assumed to be the product of the angular frequency and the radius, this yields the ratio of yaw rate Ω to two times the angular frequency as the ratio of the centrifugal force to the Coriolis force, i.e., for example, at a drive frequency of 20 kHz and a yaw rate of 1000 degrees per second, which is already selected to be relatively high, the result is a ratio of the absolute value of the centrifugal force to the absolute value of the Coriolis force of 7200. Although the centrifugal signal occurs at twice the frequency, nevertheless a dynamic range of the input stage which is accordingly large must be reserved in the evaluation circuit to avoid overmodulation, thereby having a deteriorating effect on the resolution of the sensor.

### SUMMARY

An object of the present invention is therefore to make available a micromechanical structure or a yaw rate sensor, which does not have the disadvantages of the related art and which has a greater ruggedness with respect to the centrifugal force during a rotation about the axis perpendicular to the main plane of extent in the case of either a three-axle yaw rate sensor or dual-axle yaw rate sensor having one sensitive direction parallel to the main plane of extent of the substrate and one sensitive direction perpendicular to the main plane of extent of the substrate.

The micromechanical structure according to the present invention and the yaw rate sensor according to the present invention have an advantage over the related art that a greater ruggedness with respect to the centrifugal force is achievable during a rotation about the axis of rotation perpendicular to the main plane of extent. It is advantageously possible in this way to obtain a greater sensitivity of the sensor and of the micromechanical structure with respect to a rotation about the axis of rotation (hereinafter also referred to as the first axis of rotation), which is perpendicular to the main plane of extent of the substrate of the micromechanical structure. Furthermore, it is advantageously possible according to the present invention to implement the aforementioned advantages together with a very compact implementation of a triple-channel (or dual-channel) yaw rate sensor or a corresponding micromechanical structure, so that the space required for implementation of the micromechanical structure is particularly small and therefore also the cost is minimizable to a particular extent. According to the present invention, the reduced dependence on the centrifugal force is achieved by the fact that a yaw rate sensor configuration situated in the interior of a rotational oscillating element is no longer connected to the rotational oscillating element by at least one first connection but instead is also connected to the substrate by at least one second connection. The influence on or superpositioning of the useful sensor signal (Coriolis signal) may be reduced significantly or even prevented by the centrifugal signal in this way or by the effect of centrifugal acceleration, resulting in a better and more accurate evaluation of the yaw rate signal according to the present invention, and on the whole, the sensor configuration and the micromechanical structure have a greater efficiency.

Exemplary embodiments and refinements of the present invention are described herein with reference to the accompanying drawings.

According to one preferred exemplary embodiment of the present invention, it is provided that the yaw rate sensor configuration has a first yaw rate sensor element and a second yaw rate sensor element, the micromechanical structure being configured to drive the first and second yaw rate sensor elements to an opposite drive direction parallel to a drive direction, so that for implementing the drive movement, the rotational oscillating element is connected with the aid of a first connection to the first yaw rate sensor element and with the aid of another first connection to the second yaw rate sensor element. It is advantageously possible in this way according to the present invention that a particularly accurate detection of the rotational movement about the axis perpendicular to the sensor substrate plane (main plane of extent of the substrate) is made possible.

According to another preferred exemplary embodiment of the present invention, it is also provided that the first connection has a first spring and the additional first connection has a second spring, the first and second springs each having a lower spring stiffness in the direction parallel to the first direction and in the direction perpendicular to the drive movement of the yaw rate sensor configuration than in the direction parallel to the drive movement of the yaw rate sensor configuration. It is advantageously possible in this way according to the present invention that a reliable drive of the yaw rate sensor configuration is implementable in the interior of the rotational oscillating element due to the rotational oscillating movement of the rotational oscillating element and nevertheless a coupling of the movement components perpendicular to the drive direction of the yaw rate sensor configuration (i.e., both parallel to the main plane of extent perpendicular to the drive direction and also in the direction perpendicular to the main plane of extent of the substrate) may be prevented and thus the purest possible linear drive of the yaw rate sensor configuration is possible (despite the drive due to the rotational oscillating element and the associated rotational movement and despite the deflection of the rotational oscillating element perpendicular to the main plane of extent and due to yaw rate components occurring parallel to the main plane of extent). According to the present invention in particular, it is provided that the first and second springs each have a much lower spring stiffness in the direction parallel to the first direction and in the direction perpendicular to the drive movement of the yaw rate sensor configuration than in the direction parallel to the drive direction of the yaw rate sensor configuration, in particular a lower spring stiffness by a factor of 10, 50 or 100 than in the direction parallel to the drive direction of the yaw rate sensor configuration.

According to another preferred exemplary embodiment of the present invention, it is also provided that the first yaw rate sensor element is connected to the substrate via the second connection and that the second yaw rate sensor element is connected to the substrate with the aid of another second connection. It is possible in this way according to the present invention to reduce the influence of the centrifugal force on the evaluation of the yaw rate sensor or the micromechanical structure in a particularly advantageous manner, in particular for evaluation of a yaw rate about the direction (first direction) perpendicular to the main plane of extent.

Furthermore, it is preferred according to the present invention that the second connection has a third spring and the other second connection has a fourth spring, the third and fourth springs each having a greater spring stiffness in the direction parallel to the first direction and in the direction perpendicular to the drive movement of the yaw rate sensor configuration than in the direction parallel to the drive movement of the yaw rate sensor configuration. It is advantageously possible in this way according to the present invention that the movement of the yaw rate sensor configuration within the rotational oscillating element is in turn decoupled from the movement of the rotational oscillating element.

In addition, it is also preferably provided according to the present invention that the first yaw rate sensor element has a first detection configuration and a first detection element and the second yaw rate sensor element has a second detection configuration and a second detection element. It is advantageously possible in this way according to the present invention that a particularly good decoupling of the detection element and of the detection configuration from the movement of the rotational oscillating element surrounding the yaw rate sensor configuration is possible.

Furthermore, it is also preferable according to the present invention that the micromechanical structure has first detection means for detecting a deflection of the first detection element and second detection means for detecting a deflection of the second detection element in a direction perpendicular to the drive direction and in a plane parallel to the main direction of extent. Furthermore, it is also preferable for the micromechanical structure to be configured not only for detecting the first and second yaw rate but also for detecting a third yaw rate about a third direction extending parallel to the main plane of extent and perpendicularly to the second direction. In addition, it is also preferable that the micromechanical structure has a third detection means for detecting a deflection parallel to the first direction and for detecting the second yaw rate and that the micromechanical structure has fourth detection means for detecting a deflection parallel to the first direction and for detecting the third yaw rate.

Exemplary embodiments of the present invention are described in greater detail in the following description with reference to the accompanying drawings.

### BRIEF DESCRIPTION OF THE DRAWINGS

FIG. 1 shows a schematic diagram of a micromechanical structure according to the present invention.

FIGS. 2 through 8 show schematic diagrams of micromechanical structures according to the present invention, in particular yaw rate sensors according to alternative exemplary embodiments.

### DETAILED DESCRIPTION

In the various figures, the same parts are always provided with the same reference numerals and therefore will generally be mentioned and explained only once each.

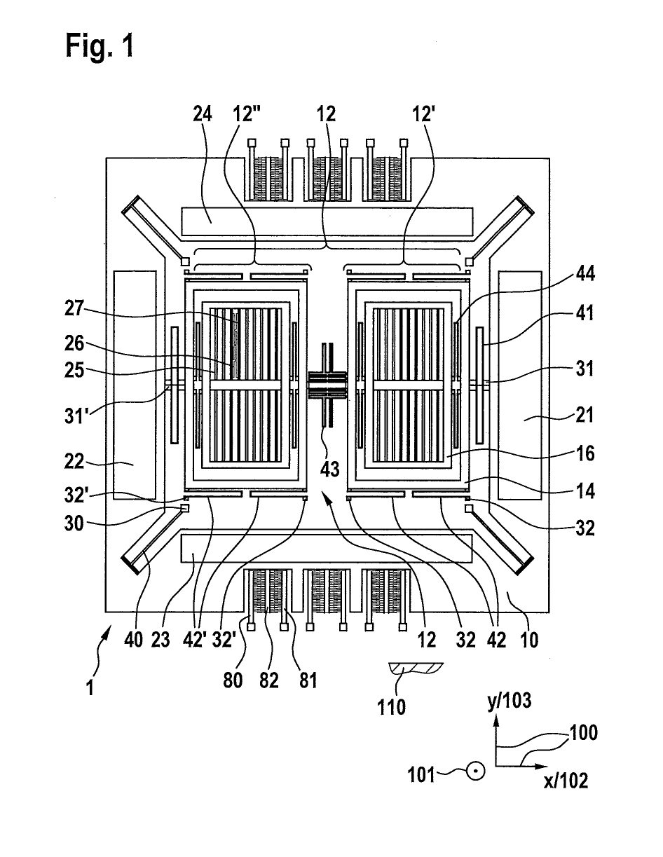

FIG. 1 shows a schematic diagram of a micromechanical structure according to the present invention, in particular a yaw rate sensor. The micromechanical structure is labeled with reference numeral 1 on the whole. Micromechanical structure 1 has a substrate, which is shown only schematically and is labeled with reference numeral 110. Substrate 110 has a main plane of extent 100, which is indicated schematically at the lower right of FIG. 1 with a second direction 102 and a third direction 103 as well as axial notation x for second direction 102 and y for third direction 103. A first direction 101 is to be imagined as perpendicular to main plane of extent 100 and is also provided with notation z. Micromechanical structure 1, which is designed in particular as a yaw rate sensor, in particular as a dual-channel or triple-channel yaw rate sensor, is provided at least for detecting a first yaw rate about first direction 101 extending perpendicularly to main plane of extent 100, for detecting a second yaw rate about second direction 102 (which extends parallel to main plane of extent 100) and optionally for detecting a third yaw rate about third direction 103, which also extends parallel to main plane of extent 100 but perpendicularly to second direction 102. The following description details primarily a triple-channel yaw rate sensor, but the present invention may also be applied to a dual-channel configuration for sensing the Ω_{x/y} and Ω_{z} yaw rates. Micromechanical structure 1 therefore has a rotational oscillating element 10, which is connected to substrate 110 with the aid of connection points 30 and spring elements 40 to rotate in relation to substrate 110. Rotational oscillating element 10 according to the design of micromechanical structure 1 in FIG. 1 is provided as an essentially square element or square ring element capable of executing a rotational oscillation about first direction 101 in this way, the axis of rotation being located in the area of the midpoint or at the midpoint of the square configuration of rotational oscillating element 10. Rotational oscillating element 10 has a recess—typically in the middle or in a central area of rotational oscillating element 10—so that a yaw rate sensor configuration 12 may be situated in rotational oscillating element 10 or in the recess of rotational oscillating element 10. Rotational oscillating element 10, which is also referred to as an oscillating frame 10, is connected to substrate 110 via spring elements 40, in particular four spring elements, at connection points 30, in particular four connection points, so that in the exemplary embodiment according to FIG. 1, spring elements 40 running essentially radially in relation to the rotational oscillating axis (first direction 101) are provided.

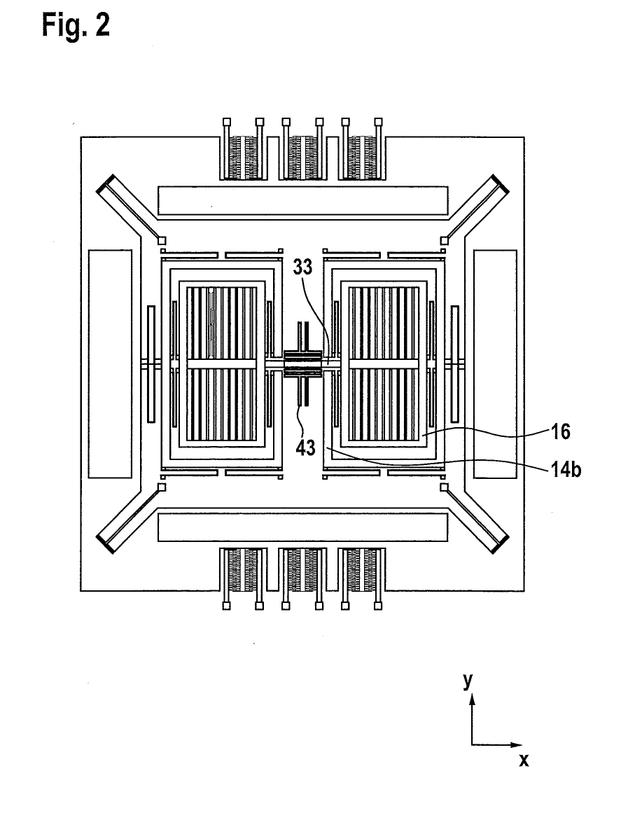

According to the present invention, the micromechanical structure has a drive means 80, 81, 82, the drive means being capable of driving rotational oscillating element 10 to rotational oscillation about the first direction or about an axis of rotation parallel to first direction 101. For this purpose, stationary drive combs 80, 81 having finger electrodes in particular and a movable drive comb 82 are provided. Stationary drive combs 80, 81 are each connected to substrate 110, while movable drive comb 82 is connected to rotational oscillating element 10. According to the present invention, the drive means may have a plurality of such drive combs. FIG. 2 shows three such drive structures in the lower part of the micromechanical structure and three such drive structures in the upper part of micromechanical structure 1. However, according to the present invention, it may also be provided that corresponding drive structures are situated in the right and left bars of the oscillating frame. Oscillating frame 10 or rotational oscillating element 10 may be excited by the drive means to a rotational oscillation about the first axis (z axis). According to other exemplary embodiments of the present invention, it is provided that oscillating frame 10 is designed to be angular but not square, instead being rectangular or round, or having an annular or elliptical shape.

During yaw rates about second and third axes 102, 103 (the x axis and the y axis), the structure of oscillating frame 10 or of rotational oscillating element 10 tilts about third direction 103 and about second direction 102, thus resulting in changes in the distance of oscillating frame 10 or of rotational oscillating element 10 from substrate 110. These changes in distance are detected with the aid of detection electrodes 21, 22, 23, 24 situated beneath rotational oscillating element 10 or oscillating frame 10 in particular. The electrodes labeled with reference numerals 21 and 22 as well as third detection means for detecting a local deflection of rotational oscillating element 10 parallel to the first direction are also provided for detecting the third yaw rate about third direction 103. In addition, the detection electrodes labeled with reference numerals 23 and 24 are hereinafter also referred to as fourth detection means for detecting a local deflection of the rotational oscillating element parallel to the first direction and for detecting the second yaw rate about second direction 102. This corresponds to the functionality of the oscillating disk according to German Application Nos. DE 199 15 257 and DE 10 2006 052 522, for example.

Yaw rate sensor configuration 12 is situated inside the oscillating frame 10 or rotational oscillating element 10, which includes, in the exemplary embodiment shown in FIG. 1, a first yaw rate sensor element 12′ and a second yaw rate sensor element 12″ connected to one another via a coupling spring 43, allowing movements in both the x and the y directions (i.e., in second and third directions 102, 103). Rotational oscillating element 10 is connected to yaw rate sensor configuration 12 via at least one connection 31, 31′, in particular with the aid of first connection 31 to first yaw rate sensor element 12′ and with the aid of another first connection 31′ to second yaw rate sensor element 12″, first connection 31 and additional first connection 31′ being situated on different sides with respect to the rotational oscillating element or on different sides with respect to yaw rate sensor configuration 12. First connection 31 has a first spring 41 and additional first connection 31′ has a second spring 41′, so that first and second springs 41, 41′ each have a lower spring stiffness in the direction parallel to the first direction and in the direction perpendicular to the drive movement of yaw rate sensor configuration 12 than in the direction parallel to the drive movement of yaw rate sensor configuration 12. Yaw rate sensor configuration 12 is also connected to substrate 110 according to the present invention via a second connection 32, 32′. Second connection 32 is therefore provided as a substrate anchor of first yaw rate sensor element 12′ and another second connection 32′ is provided as a connection of second yaw rate sensor element 12″ to substrate 110. Second connection 32 includes a third spring 42 and additional connection 32′ includes a fourth spring 42′, third spring 42 and fourth spring 42′ each having a greater spring stiffness in the direction parallel to first direction 101 and in the direction perpendicular to the drive movement of yaw rate sensor configuration 12 than in the direction parallel to the drive movement of yaw rate sensor configuration 12. Due to the very local first connection 31 or additional first connections 31′, it is ensured that in the rotational movement of rotational oscillating element 10 or rotational frame 10, only a very low transverse force occurs perpendicular to the drive direction (in the exemplary embodiment shown in FIG. 1, the drive direction of yaw rate sensor configuration 12 coincides with third direction 103 (also referred to as the y direction)). However, this coincidence need not necessarily be the case according to the present invention. The drive direction could also be provided according to second direction 102 or could also be at an angle not equal to 90° to second or third directions 102, 103. The remaining transverse force is essentially captured with the aid of first and second springs 41, and 41′, which are soft in the direction perpendicular to the drive direction, since frame structure 14 or drive element 14 is connected to substrate 110 via third and fourth springs 42, 42′, which are extremely stiff perpendicularly to the drive direction, so that frame 14 or drive element 14 is practically unable to deflect in the direction perpendicular to the drive direction. However, first and second springs 41, 41′ are very stiff parallel to the drive direction (third direction 103 in FIG. 1) and they entrain frame 14 or drive element 14 in the drive direction. Thus a joint drive mode of oscillating frame 10 or of rotational oscillating element for Ωₓ_{^{−}} detection and Ω_{y}_{^{−}} detection (i.e., the second and third yaw rates) and of linear oscillator 12 or yaw rate sensor configuration 12 is formed for Ω_{z}_{^{−}} detection (i.e., for the first yaw rate). First and second drive elements 14, 14′ of the yaw rate sensor configuration then move parallel to the drive direction in phase opposition, which coincides with third direction 103 in the example shown here. However, the occurrence of centrifugal accelerations in yaw rate sensor configuration 12 is effectively suppressed at the same time. First and second detection configurations 16, 16′ of yaw rate sensor configuration 12 are entrained during the drive movement via springs 44 and 44′, which are stiff in the drive direction (i.e., they also move in phase opposition in relation to one another). When yaw rates occur about first axis 101 (i.e., during occurrence of a yaw rate component corresponding to the first yaw rate), Coriolis forces occur parallel to second direction 102 and detection configurations 16, 16′ each deflect accordingly in phase opposition in parallel with second direction 102. The deflections are detected capacitively according to the present invention by movable electrodes 25 and stationary electrodes 26, 27 in particular, which are mentioned only as examples and which together form two detection means for detecting the outside deflection of second detection configuration 16′. Corresponding electrodes for the first detection means (not shown) are provided for detecting a deflection of first detection configuration 16 according to the present invention but are not shown here for the sake of simplicity. First and second detection configurations 16, 16′ are designed as Coriolis masses in the exemplary embodiment according to FIG. 1, i.e., detection configurations 16, 16′ complete the drive movement (which is why a Coriolis force is acting on them) and also complete the detection movement. First and second springs 41, 41′ must be stiff in the drive direction and soft in the direction perpendicular to the drive direction, and must also be soft in the direction of first direction 101 (the z direction), so that the oscillating frame or rotational oscillating element 10 is able to tilt about third direction 103 when Ωₓ_{^{−}} yaw rates occur (i.e., the second yaw rate about second direction 102, the x direction). As variants of first and second springs 41, 41′ implemented in the form of meandering springs, for example (i.e., as U springs or S springs), springs designed as plate springs, for example, i.e., having a much smaller layer thickness than the usual sensor structure, may also be implemented according to the present invention.

FIGS. 2 through 8 show schematic diagrams of micromechanical structures according to the present invention, in particular yaw rate sensors according to alternative exemplary embodiments.

FIG. 2 shows an alternative preferred exemplary embodiment of the triple-channel yaw rate sensor according to the present invention. In contrast with the exemplary embodiment according to FIG. 1, drive frame 14 or first drive element 14 (and second drive element 14′) are designed according to a variant of the design according to FIG. 1 and are labeled with reference numeral 14b. In this alternative, first (and second) drive element 14 is open on the frame legs situated on the inside, so that coupling spring 43 connects the two detection frames 16, 16′ directly (i.e., first and second detection configurations 16, 16′) to one another with the aid of connecting elements 33. This ensures that the two partial oscillators of linear oscillator structure 12 (or of yaw rate sensor configuration 12) are not only strongly coupled in the drive movement but also in the detection movement and thus form a joint antiparallel detection mode. First and second detection configurations 16, 16′ are also designed as Coriolis masses according to the exemplary embodiment in FIG. 2, i.e., detection configurations 16, 16′ complete the drive movement (which is why a Coriolis force acts on them) as well as the detection movement. However, only in the case of weakly coupled detection structures, as in the exemplary embodiment according to FIG. 1, is it possible for two almost independent detection oscillating shapes to develop in the right and left partial oscillators, which could also result in slightly different resonant frequencies in the case of minor structural differences in springs and masses due to the process. This may have negative effects on the signal quality of the yaw rate sensor, in particular the vibration strength. Such disadvantages are avoided by coupling detection frames 16 according to the exemplary embodiment in FIG. 2.

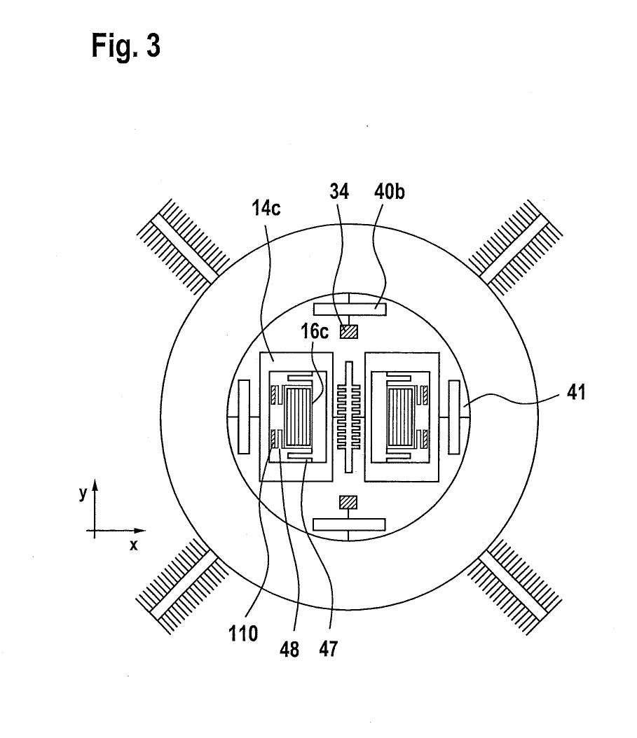

FIGS. 3 through 8 show alternative exemplary embodiments of the triple-channel yaw rate sensor according to the present invention, which have an outer oscillating frame or an outer rotational oscillating element 10 in the form of a circular disk (having an internal recess) instead of the rectangular geometry according to FIGS. 1 and 2.

According to the exemplary embodiment in FIG. 3, in contrast with the exemplary embodiments according to FIGS. 1 and 2, drive frame 14 or first drive element 14 (and second drive element 14′ accordingly)—labeled with reference numeral 14c according to FIG. 3—is not connected to substrate 110. Drive frame 14c therefore fulfills the functionality of a Coriolis frame, i.e., a frame movable both in the drive direction and in the detection direction. An applied Coriolis force results in deflection of structure 14c in the x direction. A detection structure 16c (which corresponds to first detection configuration 16 or second detection configuration 16′ in FIG. 1 but is connected differently) is also moved in the x direction by springs 47, which are stiff in the x direction, and thus results in a detection signal. Detection structure 16c is at rest during the drive movement in this configuration, i.e., it does not execute any movement in drive direction y. This is made possible by springs 48, which are stiff in the y direction and are connected to substrate 110. This results in a further advantageous decoupling of the drive movement and the detection movement. In addition, local process fluctuations, namely the slight structuring differences in springs and masses as mentioned above, result in a smaller quadrature. Springs 48 according to the exemplary embodiment of the present invention in FIG. 3 correspond to second connection 32, 32′ of yaw rate sensor configuration 12 on substrate 110. Another topological difference in comparison with the structures according to FIGS. 1 and 2 includes two springs 40b instead of four anchoring springs 40, which connect the sensor to substrate 110 at anchoring points 34 and greatly resemble springs 41 between the oscillating frame and frame elements 14c. This improves the symmetry of the detection deflections for yaw rates about the x and y axes, i.e., tilting of the oscillating frame about the x and y axes.

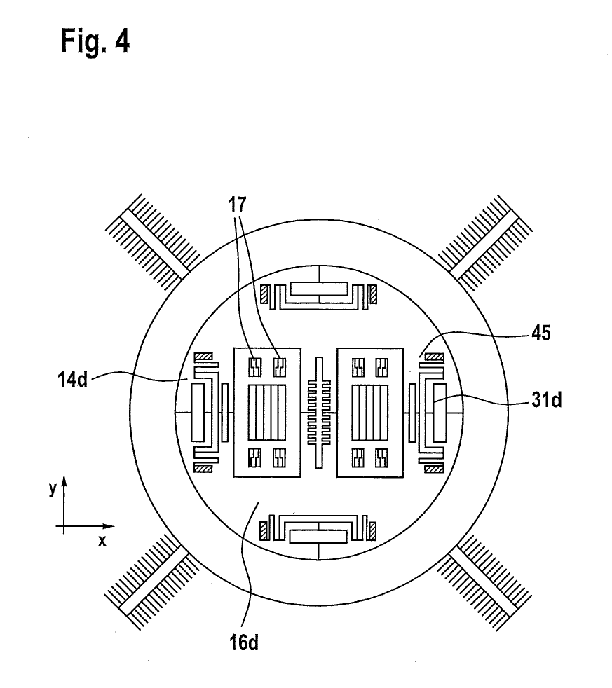

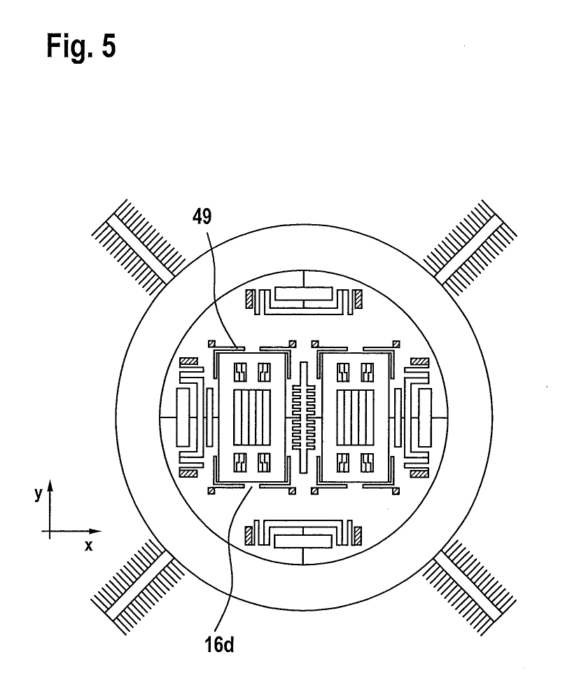

FIG. 4 shows an alternative and preferred exemplary embodiment of the triple-channel yaw rate sensor according to the present invention. In contrast with FIGS. 1 and 2, in the exemplary embodiment according to FIG. 4, yaw rate sensor configuration 12 was modified such that first and second drive elements 14, 14′ are each reduced to a compact structure as drive frame 14d. This implementation of first and second drive elements 14, 14′ is also provided in the exemplary embodiments according to FIGS. 5 through 8. Cross-coupling of the x component of the drive movement to detection structure 16d, which is also modified according to FIG. 4, is further suppressed by the substrate connection of springs 45 outside of, in particular above and below, the point of contact of spring 31d (which corresponds to first and second springs 41, 41′ according to FIG. 1), so that this is practically not deflected at all in the x direction and thus does not result in a faulty signal. In addition, it is provided according to the exemplary embodiment in FIG. 4 that detection structure 16d contains quadrature compensation structures 17, which compensate for a mechanical quadrature signal with the aid of an electrostatic force.

The exemplary embodiment according to FIG. 5 corresponds to the exemplary embodiment according to FIG. 4 with regard to drive frame 14d, but detection structure 16d is connected to substrate 110 by flexible springs 49 in the x and y directions. This results in additional possibilities with regard to adjustment of the detection frequency of the z channel (i.e., for sensing the first yaw rate about z axis Ω_{z}.

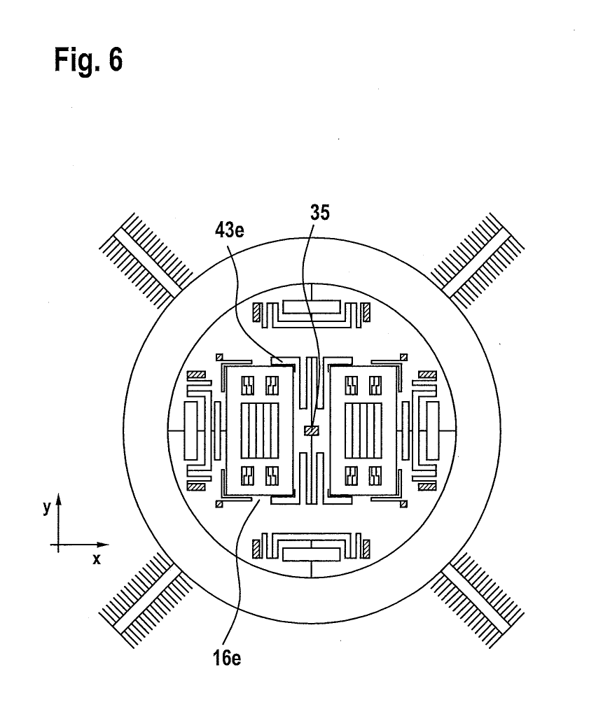

FIG. 6 shows another alternative and preferred exemplary embodiment of the triple-channel yaw rate sensor according to the present invention. An alternative implementation of coupling structure 43 according to the exemplary embodiment in FIG. 1 is connected to substrate 110 at an anchoring point 35 as coupling structure 43e between both detection frames 16e. Spurious modes capable of falsifying the measuring signal are shifted toward higher frequencies in this way.

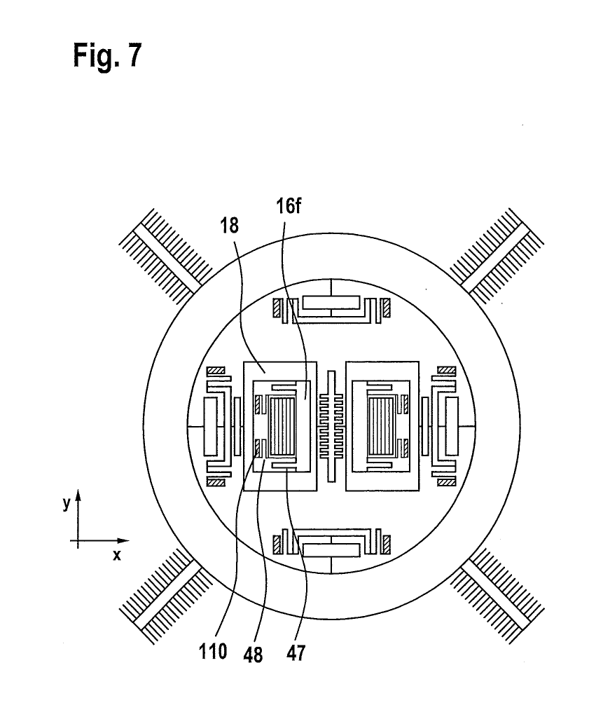

FIG. 7 shows an alternative exemplary embodiment of the triple-channel yaw rate sensor according to the present invention. In contrast with the exemplary embodiments according to FIGS. 3, 4 and 5, a Coriolis frame 18 is provided in the exemplary embodiment according to FIG. 6, forming first and second drive elements 14, 14′ together with drive frame 14d. Coriolis frame 18 is not connected to substrate 110 and is movable both in the drive direction and in the detection direction. An applied Coriolis force results in a deflection of Coriolis frame 18 in the x direction. Detection structure 16f (which together with the detection structure situated in mirror image plays the role of first and second detection configurations 16, 16′ according to FIG. 1) is also moved in the x direction by springs 47, which are stiff in the x direction, thus resulting in a detection signal. Detection structure 16f is at rest during the drive movement in this configuration, i.e., it does not execute any movement in drive direction y. This is made possible by springs 48, which are stiff in the y direction and are connected to substrate 110 at anchoring points. This results in a further advantageous decoupling of the drive movement and the detection movement. In addition, local process fluctuations result only in a small quadrature.

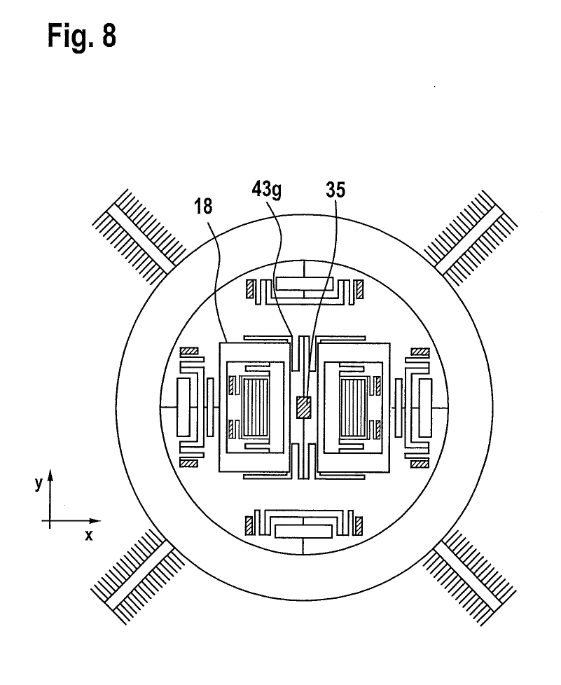

FIG. 8 shows another alternative and preferred exemplary embodiment of the triple-channel yaw rate sensor according to the present invention. In comparison with the exemplary embodiment according to FIG. 7, coupling structure 43g (corresponding to coupling structure 43e in the exemplary embodiment in FIG. 6) is connected to substrate 110 at the center between two Coriolis frames 18 (implemented according to the exemplary embodiment in FIG. 7) at an anchoring point 35. Spurious modes capable of falsifying the measuring signal are shifted toward higher frequencies in this way.

What is claimed is:

1. A micromechanical structure, in particular a yaw rate sensor having a substrate including a main plane of extent for detecting a first yaw rate about a first direction extending perpendicularly to the main plane of extent and for detecting a second yaw rate about a second direction extending parallel to the main plane of extent, comprising:
a rotational oscillating element adapted to be driven to a rotational oscillation about an axis of rotation parallel to the first direction,
a yaw rate sensor configuration adapted for detecting the first yaw rate, the rotational oscillating element completely surrounding the yaw rate sensor configuration in a plane parallel to the main plane of extent,
at least one first connection of the yaw rate sensor configuration on the rotational oscillating element, and
at least one second connection of the yaw rate sensor configuration on the substrate.

2. The micromechanical structure according to claim 1, wherein the yaw rate sensor configuration includes a first yaw rate sensor element and a second yaw rate sensor element, the micromechanical structure being adapted to drive the first and second yaw rate sensor elements parallel to a drive direction to an opposite drive movement, so that for implementing the drive movement, the rotational oscillating element is connected to the first yaw rate sensor element via the first connection and is connected to the second yaw rate sensor element via an additional first connection.

3. The micromechanical structure according to claim 2, wherein the first connection includes a first spring and the additional first connection includes a second spring, the first and second springs each having a lower spring stiffness in the direction parallel to the first direction and in the direction perpendicular to the drive movement of the yaw rate sensor configuration than in the direction parallel to the drive movement of the yaw rate sensor configuration.

4. The micromechanical structure according to claim 2, wherein the first yaw rate sensor element is connected to the substrate via the second connection, and the second yaw rate sensor element is connected to the substrate via an additional second connection.

5. The micromechanical structure according to claim 4, wherein the second connection has a third spring and the additional second connection has a fourth spring, the third and fourth springs each having a greater spring stiffness in the direction parallel to the first direction and in the direction perpendicular to the drive movement of the yaw rate sensor configuration than in the direction parallel to the drive movement of the yaw rate sensor configuration.

6. The micromechanical structure according to claim 2, wherein the first yaw rate sensor element has a first drive element and a first detection configuration, and the second yaw rate sensor element has a second drive element and a second detection configuration.

7. The micromechanical structure according to claim 6, further comprising:
first detection means adapted for detecting a deflection of the first detection configuration and second detection means adapted for detecting a deflection of the second detection configuration in a direction perpendicular to the drive direction and in a plane parallel to the main direction of extent.

8. The micromechanical structure according to claim 1, wherein the micromechanical structure is adapted not only for detecting the first and second yaw rates but also for detecting a third yaw rate about a third direction extending parallel to the main plane of extent and perpendicularly to the second direction.

9. The micromechanical structure according to claim 9, further comprising:
third detection means adapted for detecting a deflection parallel to the first direction and for detecting the second yaw rate, and
fourth detection means adapted for detecting a deflection parallel to the first direction and for detecting the third yaw rate.

10. The micromechanical structure according to claim 1, further comprising:
a drive means adapted to drive the rotational oscillating element to the rotational oscillation about the axis of rotation parallel to the first direction.
